(19) United States
(12) Patent Application Publication
(10) Pub. No.: US 2012/0291637 A1
(43) Pub. Date: Nov. 22, 2012

(54) Milk Frother

(75) Inventor: Chunping Yu, Yuyao City (CN)

(73) Assignee: YUYAO SUNBOY ELECTRIC APPLIANCE CO., LTD., Yuyao, Zhejiang (CN)

(21) Appl. No.: 13/574,618

(22) PCT Filed: Apr. 7, 2010
(86) PCT No.: PCT/CN2010/071601

§ 371 Date: Jul. 22, 2012

(30) Foreign Application Priority Data
Jan. 21, 2010 (CN) 201020050265.X

(51) Int. Cl. B01F 13/08

(52) U.S. Cl. 99/453

(57) ABSTRACT

The present invention relates to kitchenware of electrical appliance, A milk frother comprises a container and an electrical base unit. The container is provided with a separating disc that divides the container into an upper cavity and a lower cavity. A stirrer with slave magnetic element is provided atop the separating disc. A heating device, a rotatable device and a motor are provided beneath the separating disc. the present invention utilizes a separating disc to completely insulate the upper cavity that holds milk and the working circuit that operates the stirrer so that milk will not leak into the bottom of container to affect working circuit and the lubricant of motor ii will not leak into the upper cavity to contaminate milk. So this scheme should provide a sanitary and safe milk frother. The use of magnets provides a clean and environment-friendly way to drive stirrer. The stirrer is just positioned in the upper cavity so that the stirrer can be more conveniently disassembled for cleaning.

### FIELD OF THE INVENTION

The present invention relates to kitchenware of electrical appliance, especially to a milk frother.

### PRIOR ART OF THE INVENTION

There are all kinds of milk frother in the market, including some with stirring means in their lids and requiring a long stirring arm to extend into a container, causing difficult cleaning and steam penetrating in their motor to affect service life and safety. Some stirring means, as its output axle of motor directly penetrate the milk-holding container, has high requirement on the seal between axle sleeve and heating device in order to not only avoid the lubricant of motor entering the container but also avoid the milk in the container penetrating in container bottom to affect the operating circuit inside it, otherwise severe safety misadventure may be incurred.

### SUMMARY OF THE INVENTION

Accordingly, the present invention has been keeping in mind the above problems occurring in the related art, such as the output axle of motor directly penetrating the container and extending into the milk frother, high requirement on the seal between axle sleeve and heating device, avoiding the lubricant of motor entering the container or avoiding the milk in the container penetrating in container bottom to affect the operating circuit inside it. The present invention provides a milk frother that utilizes magnets to separate the milk in upper cavity and the operating circuit in container bottom, featuring simple structure, convenient disassembly and cleaning, higher safety performance and longer service life.

The present invention can solve the above-mentioned technical difficulties by the following scheme:

A milk frother comprises a container and an electrical base unit. The container is provided with a separating disc that divides the container into an upper cavity and a lower cavity. A stirrer with slave magnetic element is provided atop the separating disc. A heating device, a rotatable device and a motor are provided beneath the separating disc. The rotatable device is positioned right beneath the stirrer and is driven by the motor. The stirrer is provided with driving magnets that produce magnetic pull to and centrifugal force from slave magnets during rotation so as to drive the stirrer to operate. When the motor begins operating, it first drives the rotatable device. As the rotatable device is provided with driving magnetic element and the stirrer is provided with slave magnetic element, the rotation of the rotatable device drives the stirrer to rotate by the effect of magnets so as to realize stirring effect. Such a design is characterized by convenient disassembly and cleaning, higher safety performance and longer service life.

As a preferred embodiment, the rotatable device is provided with M pairs of driving magnetic element with vertical polarity. Each pair of driving magnetic element is distributed symmetrically centered by the output axle of motor, and neighboring two driving magnetic elements have opposite polarity. The stirrer is provided with N pairs of slave magnetic element with vertical polarity. The slave magnetic elements are set over the driving magnetic elements. M is even and M≧2, while N satisfying 1≦N≦M−1.

As a preferred embodiment, the number M of the pairs of driving magnetic element and the number N of the pairs of slave magnetic element satisfy M=2N. The distribution of driving magnetic elements in the rotatable device and slave magnetic elements in the stirrer can be summed up as follows: The rotatable device is provided with two or more even pairs of driving magnetic elements with vertical polarity. The driving magnetic elements are distributed symmetrically around the center of the rotatable device. The pair of driving magnetic elements has the same polarity while neighboring driving magnetic elements have opposite polarity. In the case of M=2 and N=1 as shown in FIG. 6 and FIG. 7, the magnetic pull between the slave magnetic elements and the driving magnetic elements in the rotatable device with opposite polarity drives the stirrer to operate. Meanwhile the repulsive force between the slave magnetic elements and the driving magnetic elements in the rotatable device with same polarity upheaves the stirrer. As the magnetic pull and the repulsive force of the stirrer are in a relatively balanced state during rotation, the stirrer is in a state of suspension, significantly reducing its friction force during rotation. Of course, in order to avoid too large magnetic pull between the driving magnetic elements and the slave magnetic elements to cause the motor's failure of running or too large friction force between the stirrer and the positioning axle to cause idle running of motor (increase production cost), it is inadvisable to set too more magnetic elements. It is preferable to set M:N=2:1 to reach a good balance between transmission and production cost.

It is preferable to set a bracket below the heating device and mount the motor on the bracket. The rotatable device is coupled to the output axle of motor by the way of bell and spigot joint, without contacting the heating device. The heating device is a heating disc. No contacting between the rotating device and the heating device avoids overheating the rotating device so that its service life can be prolonged.

It is preferable to set a positioning axle of stirrer in the center of separating disc. The stirrer comprises a magnetic element mounting rack that has slave magnetic elements inside it and a positioning hole in its center to match with the positioning axle of separating disc. The coupling between the positioning axle and the positioning hole enables the assembly and disassembly of the stirring device to become easy. The positioning axle is set vertically on the separating disc, right over the output axle of the motor. It is preferable to set a rotatable vane is provided on the magnetic element mounting rack. A fixing ring is coupled at both ends of the magnetic element mounting rack and a fixing ring is sheathed around the fixing ring. The rotatable vane on the magnet mounting rack tremendously enhances the stirring effect of the stirring device and facilitates disassembly for cleaning. The stirring springs enable the stirring of liquid in the container to be evener, improving the stirring effect.

It is preferable to adopt the positioning hole as blind hole. The stirrer is coupled to the positioning axle by the way of bell and spigot joint. Due to small contacting area, the friction force during rotation is also very small.

It is preferable to set a spout on the container to facilitate drainage.

It is preferable to set the driving magnetic element in a rectangular form and mounted vertically inside the rectangular groove of the magnetic element mounting rack. The slave magnetic element is also in a rectangular form and mounted vertically inside the rectangular groove of the rotatable device.

It is preferable to set the driving magnetic element in an annular form and mounted inside the annular groove of the magnetic element mounting rack. The slave magnetic element is in a sector form and mounted inside the sector groove of the rotatable device.

It is preferable to set a handle on the container. The handle has a switch to ii control the operation of heating device and motor and also an indicating lamp. The container is provided with a spout. The heating device is also provided in its lower part with a thermostat to monitor the temperature of heating device. The switch comprises an individual subswitch to control the operation of the heating device and a subswitch to control the operation of the motor. Thus, the switches can individually control the operation of the heating device or the motor, or simultaneously both of them. The switch is also provided with an indicating lamp to indicate the working states of the heating device and the motor. The heating device is also provided with a thermostat in its lower part to monitor the real-time temperature of the liquid in the container conveniently.

Upon adopting the aforesaid technical scheme, the present invention utilizes a separating disc to completely insulate the upper cavity that holds milk and the working circuit that operates the stirrer so that milk will not leak into the bottom of container to affect working circuit and the lubricant of motor will not leak into the upper cavity to contaminate milk. So this scheme should provide a sanitary and safe milk frother. The use of magnets provides a clean and environment-friendly way to drive stirrer. The stirrer is just positioned in the upper cavity so that the stirrer can be more conveniently disassembled for cleaning.

### BRIEF DESCRIPTION OF THE DRAWINGS

FIG. 1 is the schematic view of structure of the embodiment 1 in the present invention;

FIG. 2 is the vertical view of FIG. 1;

FIG. 3 is the sectional view showing the stirrer of FIG. 1;

FIG. 4 is the bottom view of FIG. 3.

FIG. 5 is the sectional view of heating device and separating disc.

FIG. 6 is a schematic view of polarity configuration of driving magnetic element in the rotatable device.

FIG. 7 is a schematic view of polarity configuration of slave magnetic element corresponding to FIG. 6 in the stirrer.

FIG. 8 is another schematic view of the structure of driving magnetic element in the rotatable device.

FIG. 9 is a schematic view of polarity configuration of slave magnetic element corresponding to FIG. 8 in the stirrer.

FIG. 10 is another schematic view of the structure of stirrer.

Of which: 1-container, 2-heating device, 3-separating disc, 4-motor, 5-stirrer, 6-rotatable device, 7-switch, 8-handle, 9-electrical base unit, 11-upper cavity, 12-lower cavity, 13-spout, 14-bracket, 21-thermostat, 31-positioning axle, 50-magnetic element mounting rack, 51-positioning hole, 52-fixing ring, 53-stirring spring, 54-slave magnetic element, 55-rotatable vane, 64-driving magnetic element, 101-upper connector, 102-lower connector.

### DETAILED DESCRIPTION OF THE INVENTION

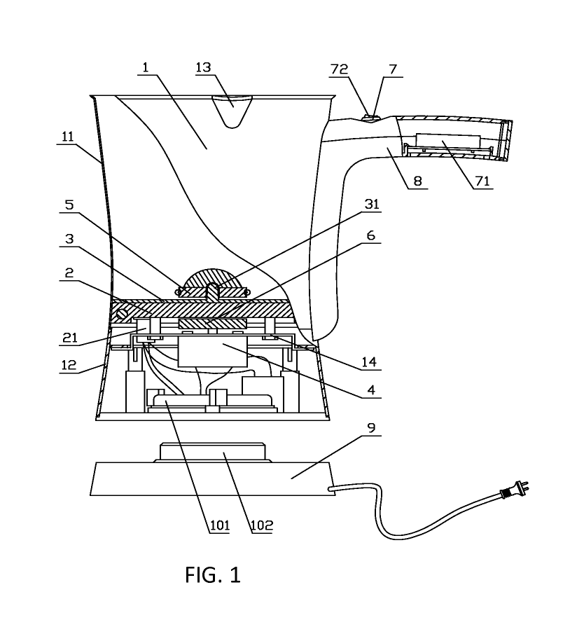

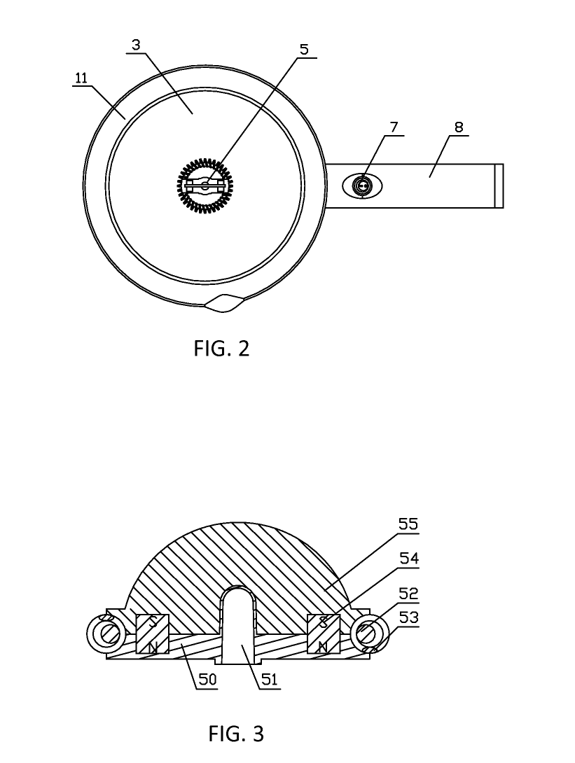

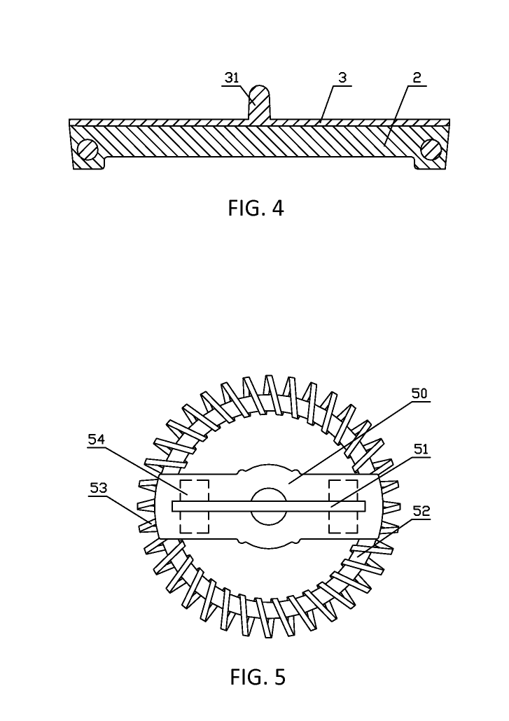

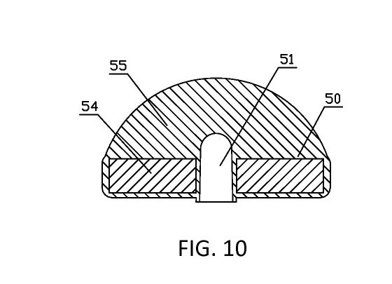

Reference will now be made in greater detail to exemplary embodiments of the invention with reference to the accompanying FIG. 1 to FIG. 10.

A milk frother as shown in FIG. 1 to FIG. 5 comprises a container 1 and an electrical base unit 9. The container 1 is provided with a separating disc 3 that divides the container 1 into an upper cavity 11 and a lower cavity 12. A stirrer 5 is provided on the separating disc 3 with slave magnetic elements 54. A heating device 2, a rotatable device 6 and a motor 4 are provided beneath the separating disc 3. The rotatable device 6 is driven by the motor 4. In the course of rotation, the rotatable device 6 that is provided with driving magnetic elements 64 drives the stirrer 5 to operate because the driving magnetic elements 64 play the roles of magnetic pull to and centrifugal force from the slave magnetic elements 54.

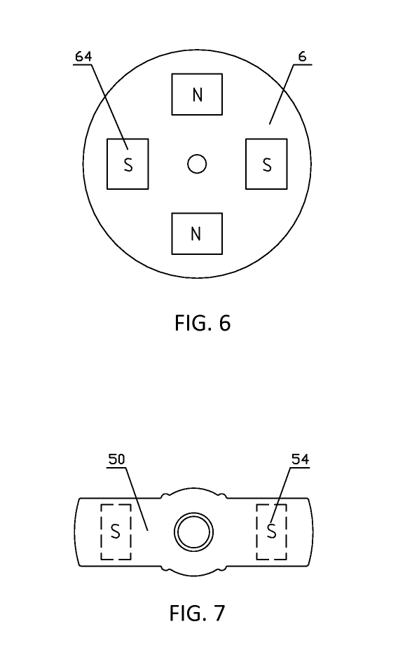

In the course of operation, the motor 4 first drives the rotatable device 6. In the course of rotation, as the rotatable device 6 is provided with driving magnetic elements 64 and the stirrer 5 is provided with slave magnetic elements 54, due to the effect of magnetic force, the rotatable device 6 drives the stirrer 5 so that the stirring is effected. Such a design has the advantages of convenient disassembly and cleaning, higher safety performance and longer service life. In the cases of M=2 and N=1 as shown in FIG. 6 and FIG. 7, the effect of attraction between the slave magnetic elements 54 and the driving magnetic elements 64 that sets an opposite polarity to the rotatable device 6 drives the stirrer 5 to rotate. Meanwhile the repulsive force between the slave magnetic elements 54 and the driving magnetic elements 64 with the same polarity as the rotatable device 6 upheaves the stirrer 5. As the attractive force and the repulsive force are in a rather balanced state in the course of rotation of the stirrer 5, the stirrer 5 is in the state of suspension so that the abrasion is significantly reduced during its rotation.

There are two pairs of driving magnetic elements 64 in the rotatable device 6 as shown in FIG. 6 and FIG. 7. The polarity of driving magnetic elements 64 is set vertical and each pair of driving magnetic elements 64 are in symmetrical distribution centered by the output shaft of motor 4. The neighboring two driving magnetic elements 64 have an opposite polarity. A pair of slave magnetic elements 54 with vertical polarity is provided in the stirrer 5 over the driving magnetic elements 64.

A bracket 14 is provided beneath the heating device 2 and the motor 4 is mounted on the bracket 14. The rotatable device 6 is coupled to the output shaft of the motor 4 by the way of bell and spigot joint without contacting the heating device 2. The heating device 2 is a heating disc. No contacting between the rotatable device 6 and the heating device 2 avoids overheating the rotatable device 6 so that its service life can be prolonged.

A positioning axle 31 is provided on the separating disc 3 to facilitate the positioning of the stirrer 5. The positioning axle 31 locates in the center of the separating disc 3. The stirrer 5 comprises a magnetic element mounting rack 50 in which the slave magnetic element 54 is mounted. A positioning hole 51 to match the positioning axle 31 of the separating disc 3 is provided in the center of the magnetic element mounting rack 50. The coupling between the positioning axle 31 and the positioning hole 51 enables the assembly and disassembly of the stirrer 5 to become easy. The positioning axle 31 is set vertically on the separating disc 3 and positioned right over the output axle of the motor 4.

A rotatable vane 55 is provided on the magnetic element mounting rack 50. A fixing ring 52 is coupled at both ends of the magnetic element mounting rack 50 and a fixing ring 53 is sheathed around the fixing ring 52. The rotatable vane 55 on the magnetic element mounting rack 50 tremendously enhances the stirring effect of the stirrer 5 and facilitates the disassembly for cleaning. The stirring springs 53 enable the stirring of liquid in container 1 to be evener, improving the stirring effect.

An upper connector 101 is provided in the lower part of container 1 and a lower connector 102 is provided in the electrical base unit 9 to match the upper connector 101.

An electrical base unit provided below the container is a 360° power connector that comprises an upper connector in the bottom of lower cavity 12 and the lower connector 102 in the electrical base unit 9 that matches with the upper connector 101. The upper cavity 11 and the separating disc 3 are made of stainless steel sheet with weak magnetic property.

The container 1 is provided with a handle 8 that has a switch 7. The switch 7 controls the operation of the heating device 2 and the motor 4, and also has an indicating lamp 72. The container 1 is provided with a spout 13. The heating device 2 is also provided with a thermostat 21 in its lower part to monitor the temperature the heating device 2. The switch 7 also comprises an individual subswitch to control the operation of the heating device 2 and a subswitch to control the operation of the motor 4. Thus, the switches can individually control the operation of the heating device or the motor or simultaneously both of them. The switches also have lamps to indicate the working states of the heating device and the motor. The heating device 2 is also provided with a thermostat 21 in its lower part to monitor the real-time temperature of the liquid in the container conveniently. The container 1 is provided with a spout 13 to facilitate drainage.

The positioning hole 51 is a blind hole. The stirrer 5 is coupled to the positioning axle 31 by the way of bell and spigot joint. Due to small contacting area, the friction force during rotation is also very small.

The driving magnetic element 64 is in a rectangular form and mounted vertically inside the rectangular groove of the magnetic element mounting rack 50. The slave magnetic element 54 is also in a rectangular form and mounted vertically inside the rectangular groove of the rotatable device 6. When the driving magnetic element 64 is put in the rectangular groove, the magnetic element mounting rack 50 is conveniently coupled with the rotatable vane 55.

Before the milk frother works, the mutual magnetic pull between the driving magnetic element 64 and a pair of slave magnetic elements in corresponding positions and with same polarity is greatly larger than the mutual repulsive force between the driving magnetic element 64 and a pair of slave magnetic elements 54 in neighboring positions and with opposite polarity. At this time the rotatable device 6 sucks the stirrer 5 firmly and both keep relatively stationary and balanced. When the milk frother works, the motor 4 begins operating. The motor 4 drives the rotatable device to run. The mutual magnetic pull between the driving magnetic element 64 and a pair of slave magnetic elements 54 in corresponding positions and with same polarity still exists and drives the stirrer 5. When the driving magnetic element 64 gradually accelerate its rate of rotation, it will gradually divoice from the slave magnetic elements 54. Meanwhile there is a trend of approach between the mutual repulsive force between the driving magnetic element 64 and a pair of slave magnetic elements 54 in neighboring positions and with opposite polarity, and the mutual repulsive force between them begins appearing. At this time, mutual repulsive force and mutual magnetic pull may be disintegrated into vertical force in vertical orientation and tangential force in rotating orientation in the instant of rotation of rotatable device. The orientations of tangential force of both mutual repulsive force and mutual magnetic pull are identical to the orientation of the motor's rotation and are overlaid and enlarged so as to rotate the stirrer 5. Though the orientations of the vertical forces effected by mutual repulsive force and mutual magnetic pull are opposite, yet the vertical forces of mutual repulsive force is less than that of mutual magnetic pull, plus its self weight, so that the stirrer 5 is still sucked firmly to the positioning axle 31 by the rotatable device 6 during rotation. Moreover, the friction force between the stirrer 5 and the positioning axle 31 enables the rotatable device 6 and the stirrer 5 to keep balanced in rotation so as to implement the stirring of milk.

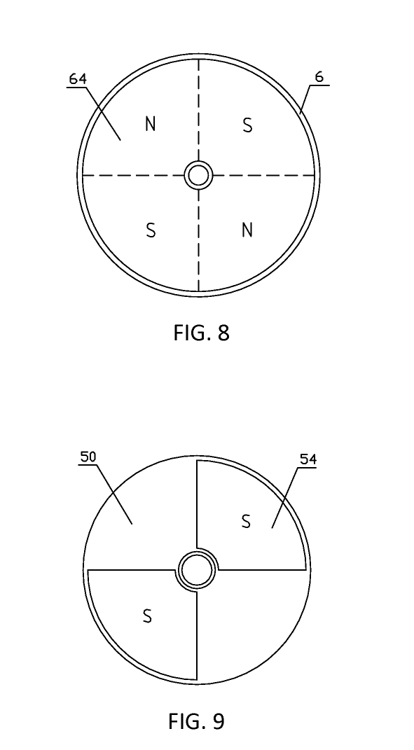

As shown in FIG. 8 to FIG. 10, when other features are the same in the above-mentioned embodiments, the driving magnetic element 64 can be of annular shape and mounted inside the annular groove of magnetic element mounting rack 50; its corresponding slave magnetic element can be of sector shape and mounted inside the sector groove of the rotatable device 6.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A milk frother , comprises:
a container (1) and an electrical base unit (9);
the container (1) is provided with a separating disc (3) that divides the container (1) into an upper cavity (11) and a lower cavity (12).;
a stirrer (5) is provided on the separating disc (3) with slave magnetic elements (54);
a heating device (2), a rotatable device (6) and a motor (4) are provided beneath the separating disc (3);
the rotatable device (6) is driven by the motor (4);
in the course of rotation, the rotatable device (6) that is provided with driving magnetic elements (64) drives the stirrer (5) to operate because the driving magnetic elements (64) play the roles of magnetic pull to and centrifugal force from the slave magnetic elements (54).

2. The milk frother of claim 1, wherein
there are two pairs of driving magnetic elements (64) in the rotatable device (6);
the polarity of driving magnetic elements (64) is set vertical and each pair of driving magnetic elements (64) are in symmetrical distribution centered by the output shaft of motor (4);
the neighboring two driving magnetic elements (64) have an opposite polarity;
a pair of slave magnetic elements (54) with vertical polarity is provided in the stirrer (5) over the driving magnetic elements (64);
M is even and M≧2, while N satisfying 1≦N≦M−1.

3. The milk frother of claim 2, wherein
the number M of the pairs of driving magnetic element and the number N of the pairs of slave magnetic element satisfy M=2N.

4. The milk frother of claim 2, wherein
a bracket (14) is provided beneath the heating device (2) and the motor (4) is mounted on the bracket (14);
the rotatable device (6) is coupled to the output shaft of the motor (4) by the way of bell and spigot joint without contacting the heating device (2).

5. The milk frother of claim 2, wherein
a positioning axle (31) is provided on the separating disc (3) to facilitate the positioning of the stirrer (5). The positioning axle (31) locates in the center of the separating disc (3);
the stirrer (5) comprises a magnetic element mounting rack (50) in which the slave magnetic element (54) is mounted;
a positioning hole (51) to match the positioning axle (31) of the separating disc (3) is provided in the center of the magnetic element mounting rack (50).

6. The milk frother of claim 5, wherein
a rotatable vane (55) is provided on the magnetic element mounting rack (50);
a fixing ring (52) is coupled at both ends of the magnetic element mounting rack (50) and a fixing ring (53) is sheathed around the fixing ring (52).

7. The milk frother of claim 5, wherein
the positioning hole (51) is a blind hole.

8. The milk frother of claim 5, wherein
the driving magnetic element (64) is in a rectangular form and mounted vertically inside the rectangular groove of the magnetic element mounting rack (50);
the slave magnetic element (54) is also in a rectangular form and mounted vertically inside the rectangular groove of the rotatable device.

9. The milk frother of claim 5, wherein
the driving magnetic element(64) in an annular form and mounted inside the annular groove of the magnetic element mounting rack (50);
the slave magnetic element (54) is in a sector form and mounted inside the sector groove of the rotatable device(6).

10. The milk frother of claim 1, wherein
the container (1) is provided with a handle (8) that has a switch (7);
the switch (7) controls the operation of the heating device (2) and the motor (4), and also has an indicating lamp (72);
the container (1) is provided with a spout (13);
the heating device (2) is also provided with a thermostat (21) in its lower part to monitor the temperature the heating device (2).
